(19) United States
(12) Patent Application Publication
(10) Pub. No.: US 2011/0226764 A1
(43) Pub. Date: Sep. 22, 2011

(54) MOBILE UNIT FOR THE CONSTRUCTION OF ELONGATED TUBULAR BODIES

(76) Inventors: Richard James Anthony Smith, Rijswijk (NL); Graham Dudley Freeth, Rijswijk (NL)

(21) Appl. No.: 12/677,708

(22) PCT Filed: Sep. 12, 2008
(86) PCT No.: PCT/EP2008/062113

§ 371 Date: Apr. 1, 2011

(30) Foreign Application Priority Data
Sep. 13, 2007 (EP) 07116327.3

(51) Int. Cl. B65D 21/02; B29C 53/58

(52) U.S. Cl. 220/23.83; 156/425

(57) ABSTRACT

The invention concerns a mobile unit for the construction of an elongated tubular body comprising an elongated, tubular inner hollow core, an elongated, tubular inner casing and an elongated, tubular outer casing, the inner casing surrounding the hollow core, the outer casing surrounding the inner casing, the outer casing comprising one or more layers, each layer consisting of one or more helically wound metal strips, the inner casing and the outer casing as well as any layers in the outer casing being bound to each other by an adhesive, which elongated body has been made by a process comprising constructing the elongated inner casing, providing one or more metal strips, winding the one or more metal strips helically around the inner casing, providing adhesive or a curable adhesive precursor and applying it between the casings and the layers, followed by curing the adhesive precursor when present, the mobile unit comprising a multitude of detachably connected containers (1-11), each container comprising equipment to carry out one or more of the process steps as described above. The invention further comprises connectable units making up the mobile unit as described above and the use of the unit.

The present invention concerns a mobile unit for the construction of an elongated tubular body, the mobile unit comprising a multitude of detachably connected containers. The invention further comprises the use of the mobile unit in the construction of elongated tubular bodies, especially for the transport of oil and gas, as well as to connectable containers making up the mobile unit.

In general, it is advantageous to try to minimize the weight of pipelines (per meter), while at the same time maintaining the specifications of the maximum allowable pressure at which the pipeline can be operated. Or, expressed in a different way, it is advantageous to increase the maximum allowable pressure at which the pipeline can be operated, while the weight (per meter) remains the same.

It is known that natural gas and liquid petroleum products may contain undesired contaminants, especially undesired acidic contaminants as carbon dioxide and hydrogen sulphide. Further, organic acids as well as chlorides may be present. It is also known that under standard operating conditions of pressure and temperature, pipelines formed of conventional materials carrying such contaminated products may be subject to failure, for instance due to stress corrosion cracking. Such failures may result in longitudinally extending fractures of the pipelines.

Previous attempts to reduce the risk of such failures have involved the use of corrosion inhibitors, added to the products being carried by the pipelines. Unfortunately, this may result in unacceptable costs including not only the cost of the inhibitors and adding them to the products but also the cost of removing and recovering the corrosion inhibitors in due course from the products carried by the pipelines. The use of corrosion inhibitors is also not advisable, particularly in offshore pipelines, due to potential environmental problems created if there is an escape of the corrosion inhibitors from the pipelines.

Alternative ways of reducing the risk of cracking, especially stress corrosion cracking, in pipes by reducing the tensile stress on the part of the pipes in contact with the contaminated products being carried have been proposed. These include the use of pipes formed of, for example, two tubes inserted one inside the other and to then during production mechanically forcing the inner pipe into contact with the outer pipe so that the inner pipe after completion of this operation has a compressive stress and the outer pipe has a tensile stress. This process is known as “auto-frettage” and one way of carrying out this operation mechanically is described in U.S. Pat. No. 4,823,847. It will be appreciated that the two pipes must be made to very tight tolerances if one is to be able to insert one into the other and perform an auto-frettage step without adversely damaging the inner pipe. It will also be appreciated that this particular auto-frettage operation is only suitable for use in small lengths of pipe and suffers from the disadvantage of being a time consuming and therefore expensive operation to carry out. A further disadvantage of the production of a pipeline from such small lengths of pipe, typically 8 to 10 meter lengths, is that it will involve numerous joints being made which in themselves are points of weakness in a pipeline.

Elongated tubular bodies of a different kind are known from U.S. Pat. No. 4,657,049 in which metal strips are helically wound in overlapping fashion and embedded in an adhesive matrix to produce a rigid tubular structure. U.S. Pat. No. 3,530,567 describes a method of forming an elongated tubular body (or pipe or pipeline) by helically winding a metal strip in self-overlapping fashion so that the thickness of the wall of the tube at any point is formed from a plurality of laps. In order to remove the helical ridges on the internal bore of the tube formed by the edges of the strip, the laps of the strip material are flattened one against the other after winding by expanding the tubular structure beyond the yield point of the metal strips. Such a procedure presents significant manufacturing difficulties.

In GB 2280889 a method is disclosed to form a hollow elongated or tubular body which comprises helically winding at least one strip of material in self-overlapping fashion to provide a multi-layer tubular structure. In this arrangement the strip is longitudinally pre-formed to provide a transverse cross-section having at least one step which, in each convolution of the strip accommodates the overlapping portion of the next convolution. A tubular body having a wall thickness formed of a plurality of laps may thus be continuously made from a single strip of material, the wall thickness generally being one strip thickness greater than the number of steps formed in the cross-section of the strip. A similar tubular body is described in WO 2006/016190.

An advantageous way to construct elongated tubular bodies comprises two or more layers of relatively simple preformed metal strips (together forming the outer casing) around a relatively light inner pipe (the inner casing). The layers in the outer casing are glued together, and preferably the outer casing is glued onto the inner casing. The preformed metal strip is a simple flat, prebended strip without any profile. The pre-bending is done under a slight angle with the longitudinal direction of the strip. Thus, the pre-bending results in a helical shape. The preformed metal strips in the finished tubular body are not self overlapping. The inner casing is preferably corrosion resistant. In this way the requirements of the pipeline (corrosion resistance and strength) are, at least partly, separated. The inner casing provides especially the corrosion resistance, the outer layers provide the major part of the strength (axial as well as radial). The hollow core in the centre of the elongated body is the space for the transport of gas and/or liquids. The process has been described in EP 07106221.0.

Using the continuous construction process as described in any of the above described processes, it is possible to construct pipelines of considerable length, i.e. several kilometres. It may be a problem to transport these long pipelines from the construction workshop to places where the pipelines are to be used. Thus, it would be an advantage to be able to construct the pipelines at those places were the pipe is be used using mobile equipment.

A number of methods are known to construct pipelines outside a workshop using mobile equipment. In U.S. Pat. No. 3,744,259 a moving pipe constructing unit is described that moves above the trench in which the pipe is to be laid. Similar moving units are known from U.S. Pat. No. 3,900,146, U.S. Pat. No. 4,651,914, U.S. Pat. No. 4,130,925, U.S. Pat. No. 4,907,732 and U.S. Pat. No. 4,452,550.

A disadvantage of the above known methods is the use of a large and heavy unit for the manufacture of the long pipes that has to be moved over the ground, often in a difficult area. It has now been found that the use of a mobile unit, that can be transported from one place to another, can be used for the continuous production of (long) pipes. In that way the (long) pipe can be transported continuously for instance via guiding rollers or over a sliding guide over a large distance. Once a suitable length has been obtained, the pipe construction process is stopped, and the mobile unit is transported to a second location, often at the opposite end of the first pipe. The mobile unit according to the invention comprises a multitude of containers, each container having a size and weight making it relatively easy to be transported. In addition, provisions may be present, e.g. openings, rings, hooks, cask-grips, for quick and easy lifting or hoisting and transporting. Each containers comprises a part of the equipment necessary for the continuous production of elongated pipes.

It is observed that in principle any distance can be made by a continuous process. In practice however, it appears that lengths between for instance 1 and 10 or 15 kilometres is a practical length to be made, as the continuous transportation of the growing pipeline becomes more difficult the longer the pipeline is. The production of several kilometres, e.g. 3 to 6 kilometres, can suitably be done in for instance one day. The practical length to be made in such a day depends for instance the slope of the stretch. A stretch going downhill by a few degrees allows a considerable longer production than a similar stretch, but going uphill by a few percent.

At the second location a second pipe can be produced, which pipe is then connected to the first one. By using detachable containers for the mobile unit, the unit can be taken apart into the smaller containers, and the containers can be transported over a (long) distance. This can be done, for instance, by using a helicopter, a boat or a truck, or combinations thereof. By repeating the process a very long pipeline can be constructed. There is no need to transport heavy machines over long distances. Further, all the required materials for the construction of the pipeline can be delivered at a limited number of places.

Thus, the present invention concerns a mobile unit, suitable for the construction of an elongated tubular body, the tubular body comprising an elongated, tubular inner hollow core, an elongated, tubular inner casing and an elongated, tubular outer casing, the inner casing surrounding the hollow core, the outer casing surrounding the inner casing, the outer casing comprising one or more layers, each layer consisting of one or more helically wound metal strips, the inner casing and the outer casing as well as any layers in the outer casing being bound to each other by an adhesive, which elongated body is to be made by a process comprising constructing the elongated inner casing, providing one or more metal strips, winding the one or more metal strips helically around the inner casing, providing adhesive or a curable adhesive precursor and applying it between the casings and the layers, followed by curing the adhesive precursor when present, with the proviso that when two or more layers are present in the outer casing of the elongated tubular body or when overlapping layers are present there may or may not be an adhesive layer between the inner and the outer casing of the elongated tubular body, the mobile unit comprising a multitude of detachably connected containers, each container comprising equipment to carry out one or more of the process steps as described above.

The invention especially concerns a mobile unit comprising at least one container in which equipment is present for the construction of the elongated inner casing. The construction of the elongated inner casing is known from the prior art. A suitable way to construct the inner casing is in a continuous way from flat metal sheets by rolling a metal sheet into a tube, preferably cold rolling, followed by longitudinally welding the rolled sheet, especially laser welding, and connecting the welded tubes to each other, preferably by welding, especially laser welding. Preferably the rolling process is done in two steps, each step converting half of the sheet into half of the tube, preferably using a three rollers assembly to bend the sheet.

In another embodiment the inner casing is made in a continuous way from flat metal sheets by pressing, preferably in a two stage pressing process, followed by longitudinally welding the rolled sheet, especially laser welding, and connecting the welded tubes to each other, preferably by welding, especially laser welding.

Another embodiment comprises the continuous manufacture of the inner casing by helically winding a flat metal strip and welding the winded strip.

In still another embodiment a long rolled metal strip is unrolled and simultaneously folded in the longitudinal direction into a tube, followed by welding the two sides to each other.

In still a further embodiment the inner casing is made in a continuous way by extrusion of a polymer, preferably an organic polymer.

The invention especially concerns a mobile unit comprising at least one container in which equipment is present for winding the one or more metal strips around the inner casing. The construction of the outer casing is known in the prior art, for instance in the patent documents cited hereinbefore. A very suitable method is described in the earlier filed European application EP 07106221.0. The process described in that document comprises the manufacture of an elongated, multilayered tubular body as described above, the outer casing comprising at least two layers, each layer consisting of one or more longitudinally preformed, flat elongated metal strips, the preforming of the strips such that the strips have been bent helically in such a way that the consecutive windings of the helix or helices touch or almost touch to each other, each strip in one layer overlapping with other strips in other layers, the layers in the outer casing being bound to each other by an adhesive, the process comprising providing an elongated inner casing, providing one or more first flat elongated metal strips, plastically preforming the one or more first metal strips in a bending process to obtain one or more helices and applying the one or more preformed first metal strips onto the inner casing to form the first layer of the outer casing, providing and applying adhesive or curable adhesive precursor, providing one or more second flat, elongated metal strips, plastically preforming the one or more second metal strips in a bending process to obtain one or more helices and applying the preformed one or more second metal strips on the first layer of the outer casing to form the second layer of the outer casing, optionally followed by the further provision and application of one or more additional layers of adhesive and preformed flat, elongated metal strips. Preferably the inner casing and the outer casing are connected to each other by adhesive.

By virtue of the feature that flat metal strips are used to prepare the preformed helix shaped outer casing layers, hardly any failures will be present in the preformed strip, for instance due to stress concentration. Especially when using high strength steel alloy, e.g. with a high proportion of its crystal grains in the martensitic phase, tubular bodies are obtained which can withstand high pressures. The use of especially corrosion resistant inner casings will reduce any stress corrosion. By using overlapping layers of preformed strips in the outer casing a substantial portion of the axial load may be taken up by the outer casing. The tubular bodies of the present invention may withstand the same internal pressure, while a material weight saving of 40% or more is obtained when compared with standard pipe. Especially the combination of high martensitic phase content steel strips and pre-bending is advantageous as without pre-bending the finished pipe product will contain a large amount of elastic deformation energy, which makes the production process as well as any repairs a difficult procedure.

The pre-bending of the strip involves applying suitable forces to obtain a helix shaped strip by plastic deformation of the metal. In the case that a layer is formed by one metal strip, the diameter of the helix (without any forces causing elastic deformation) is of the same order of magnitude as the inner casing, while the consecutive windings of the helix just touch to each other or show a small gap or overlap that can be overcome by elastic deformation of the metal only, to obtain a small gap as defined below. The diameter of the helix may be between 0.6 and 1.4 times the diameter of the inner casing, suitably, the diameter of the helix is between 0.8 and 1.25 times the diameter of the inner casing, preferably between 0.9 and 1.12, more preferably between 0.97 and 1.04.

In principle there are no restrictions as to the diameter of the tubular body. Suitably the inner hollow core has a diameter of between 5 and 250 cm, preferably between 10 and 150 cm, more preferably between 15 and 125 cm. The outer casing will comprise at least two layers. When using only one layer, the axial load resistance would be too low. In principle, there is no limit to the maximum number of layers, but a practical number will be up till 24, especially up till 20. Suitably the outer casing comprises between 2 and 16 layers, preferably between 2 and 10 layers, more preferably between 3 and 8 layers, especially 4-6 layers. It will be appreciated that more layers will result in pipes that can withstand higher pressures. Also a higher axial strength is obtained.

The elongated tubular body, when comprising one strip in each layer, suitably has a ratio circumference/strip width between 3 and 40, preferably 4 and 28, more preferably between 6 and 20, the circumference being the circumference of the smallest layer (or the first layer around the hollow core) of the outer casing. In the case of more than one strip in a layer, the strip width is defined as the sum of the strip widths in that layer.

The distance between two windings in one layer in the outer casing is preferably relatively small. In that way the forces can be transferred relatively easy without any potential problems with respect to cracking of adhesive layers. Suitably, the axial gap, if present, between two consecutive helix windings is at most a quarter of the strip width, preferably at most a sixth of the strip width, more preferably at most a tenth of the strip width. Sufficient overlap between the layers is thus obtained to transfer the forces. Suitably the gap between two windings of the strip is at most 1 cm, preferably at most 0.4 cm, more preferably at most 0.1 cm.

The distance between the inner casing and the first layer in the outer casing is suitably at most 2 mm, preferably between 0.01 and 1 mm. In a similar way, the distance between two layers in the outer casing is at most 2 mm, preferably between 0.01 and 1 mm. Normally the gap between the inner casing and the first layer and between the layers in the outer casing will be filled with adhesive. In a preferred embodiment, in which the tubular body is treated by an auto-frettage technique, most empty spaces, preferably all empty spaces, between the inner casing and the layers, will be removed. In the case of one metal strip in a layer, each strip in a layer overlaps another strip in another layer in a longitudinal section for 10 till 90%, preferably for 25 till 75%, more preferably for 40 till 60%.

The outer casing of the elongated tubular body is suitably made of steel, stainless steel, titanium or aluminium, preferably a high strength steel as further defined above, especially steels with a high proportion of its material in the martensitic phase. Steel with a high amount of martensitic crystal grains is preferred in view of its high strength. The use of such steels results in tubular structures of relatively high strength and low weight. These steels have tensile strengths between 900 MPa and 1500 MPa. These steels may be obtained from Mittal Steel under the trade name “MartINsite”.

The elongated tubular body as described above is suitably made of a metal strip having a Specified Minimum Yield Stress (SMYS) of at least 100,000 lbs/square inch, preferably between 150,000 and 300,000 lbs/square inch, more preferably between 180,000 and 250,000 lbs/square inch

In a further embodiment the mobile unit comprises at least one container comprising equipment for the curing of curable adhesive precursor. In general, the elongated tubular body as discussed above suitably comprises an adhesive layer comprising a strip of adhesive applied to the inner casing and/or between the layers in the outer casing. In principle every adhesive may be used (liquid, powder etc.), but from a practical point of view a strip is preferred. Preferably, the adhesive layer comprises a curable polymer, preferably a film based epoxy having a textile carrier, more preferably Cytec FM 8210-1. The equipment for curing suitably comprises heating equipment, for instance infrared lights, to heat the elongated tube to temperatures around 160-220° C. In addition to the container comprising the curing equipment, there may be a container to cool the temperature of the elongated body down to a lower temperature, e.g. by 60 to 120° C., to a temperature between 100 and 40° C. This cooling may be provided by e.g. air or cooled air.

In another embodiment the mobile unit comprises at least one container comprising equipment for the continuous movement of the tubular body or its intermediate parts. In general, equipment to move pipelines is well known in the art. It suitably comprises equipment comprising two tracks opposite to each other and touching to the pipe, the two tracks moving the pipe forward. Such equipment is provided by Caterpillar.

The mobile unit according to the invention comprises suitably a container provided with equipment to apply a protective coating onto the elongated tubular body. The coating protects e.g. weather conditions, movements over the ground and external damages. It is a preferred option to protect the elongated tubular body as discussed above by one or more protective layers on the outside of the outer casing. Suitable coatings are polymer coatings, for example PE (polyethylene), PP (polypropylene), PU (polyurethane) and/or PVC (polyvinyl chloride) coatings, or bitumen based coatings as well as corrosion protecting paints. Combinations and/or the use of several layers of coatings may also be used. The protective layers may be applied by conventional techniques, for example winding, extrusion, coating etc.

The mobile unit may further comprise at least one additional container comprising equipment to provide conditioned air to be used to control the climate in one or more of the other containers. The equipment especially controls the temperature of the air, the humidity of the air or the dust content of the air, preferably for all other containers.

In an alternative embodiment, one or more containers may be provided with its own air conditioning control unit. Especially each containers comprises its own air conditioning equipment. Also intermediate forms, e.g. a central container providing most of the air conditioning requirements and auxiliary air conditioning equipment in one or more containers is possible.

In a further embodiment the mobile unit may comprise a container with equipment to create tension in the elongated pipeline, e.g. caterpillar equipment comprising two tracks situated opposite to each other and touching to the elongated body or to the inner casing. The tension equipment will also control the speed of moving elongated body accurately. The use of tension creating equipment in combination with a winch (for the forward movement of the elongated body) is especially advantageous, as the speed of the elongated tube is controlled very accurately, while the elongated body will not buckle. In the case that movement equipment is present in the mobile unit to push away the elongated body from the mobile unit, at a certain moment in time, especially when the elongated body is relatively long, the forces on the elongated body may result in buckling of the elongated body. Using a winch, either at a place at a distance from the mobile unit or close to or even attached to the mobile unit in combination with a fixed pulley at a distance from the mobile unit, will solve the buckling problem.

In one embodiment the mobile unit comprises at least one additional container comprising monitoring and/or controlling equipment to monitor and/or control the processes carried out in one or more of the other containers, preferably all containers. This “command and control” room is suitably provided with all necessary equipment to view, control, monitor etc. the complete process.

The invention further comprises a mobile unit in which the mobile unit comprises at least one additional container comprising housing facilities for operators. This container suitably provides food supply, sleeping facilities, recreational facilities etc. for the operators.

The mobile unit according to the invention suitably comprises one or more standardized sea containers, more particularly ISO-containers, preferably only standardized sea containers (ISO 1496 for shipping containers; further ISO 668 and 1161). The containers are suitably made from steel. In general the container is a closed box or case or chest. Thus, external weather influences are eliminated. Doors will be present to enter the container.

The mobile unit especially comprises containers which are liftable, especially by helicopter or crane, preferably have a weight up till 30 tons, preferably up till 25 tons. Transport is possible by e.g. helicopter, boat and/or truck.

The mobile unit preferably comprises strengthening constructions to connect three or more containers to each other in addition to the direct connections between the containers, preferably a frame connecting the containers to each other. Suitable connecting means are long metal beams, but also lashing equipment, e.g. standard lashing equipment as used on containerships, as strained metal cables or strained metal rods, may be used. Also frames, e.g. rectangular frames made of H-beams may be used, above, beside or below the containers.

Preferably, the mobile unit is situated on a flat, reinforced and optionally piled structure, preferably a reinforced concrete structure or a self-leveling frame.

Suitable the mobile unit produces elongated tubular bodies comprising one metal strip in each layer of the outer casing. In principle the whole tubular production process is carried out in the multitude of containers. Only raw materials as flat plates, rolled plates, rolled strips, adhesive (or precursor), coating etc. are introduced into the containers. In this way the whole production process is shielded from outside influences (humidity, dust, sand, etc.), which will improve the quality of the tubular body.

Suitably the mobile unit comprises one or more seals connecting openings in one container with openings in adjacent containers, especially for transport of the elongated tubular body or its precursors from one container to another container, the seals preferably flexible seals, especially bellows. The shape of the seals may be square, rectangular or elliptical, but preferably cylindrical or tubular bellows are used. The minimum diameter size is the same as the diameter of the elongated tubular body, but is preferably the diameter is the tubular body plus 5-50%, especially plus 10 to 20%. The length of the seal is suitably 0.1 to 5 meters, especially 0.2 to 1 meter. The use of seals prevents the ingress of sand, dust, rain etc.

Suitably the mobile unit comprises in the last container an opening provided with a sock or with an air knife, through which opening the elongated tubular body leaves the last container. The mobile unit is preferably operated at a pressure that is above ambient pressure, preferably 5-25 mbar above ambient pressure. This enhanced pressure prevents ingress of dust, sand etc. Preferably the containers comprise grated floors, allowing dust, sand etc. to collect at the bottom of the container. Dedicated entrances may be present in the container to remove the sand, dust etc. from the container bottom.

Suitably the mobile unit comprises between 2 and 25 containers, more suitably between 3 and 20, preferably between 4 and 15, more preferably between 5 and 10.

The mobile unit may also comprise a container in which a number of internal casing elements are stored. In that way, a small trip in the first unit can be overcome by using the stored elements. All containers suitably are closed containers, to avoid sand, dust, humidity, water etc. to enter the containers. In that way the highest quality of pipeline may be produced. Any openings, e.g. between containers, are connected to each other with seals or are closed with seals. Preferably the containers are also thermally insulated.

Adjacent containers are detachably connected. Detachably connections may comprise nut and bolt systems, but also clamps may be used. Standard lashing equipment may be used as is used to secure the containers on a ship.

The invention further concerns the use of the mobile unit as described above in the construction of elongated tubular bodies as described hereinbefore. More especially the use of the mobile unit in which a first elongated tubular body is made, followed by transport of the mobile unit to the opposite end of the elongated tubular body, followed by the construction of another elongated body which is attached to the first elongate tubular body, optionally followed transport of the unit to the new opposite end of the tubular body and the construction a third tubular body which is attached to the second elongated tubular body optionally followed by further elongations.

The invention is further illustrated by way of example by the following drawings:

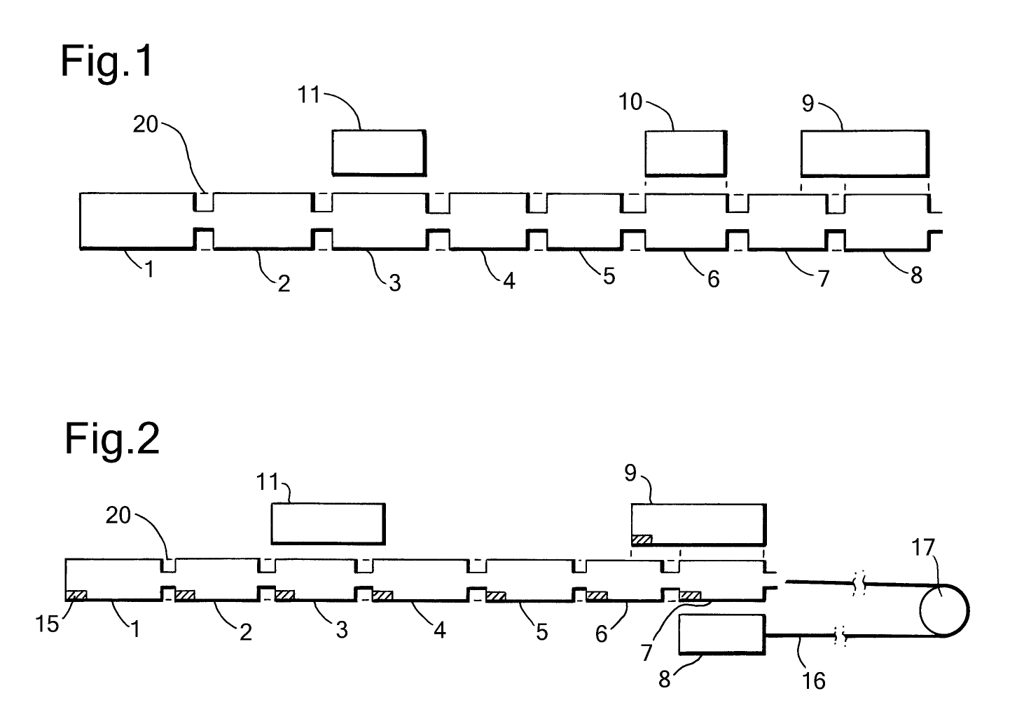

FIG. 1: mobile unit for the production of elongated tubular bodies,

FIG. 2: mobile unit for the production of elongated tubular bodies.

In FIG. 1 an outlay is depicted for a mobile unit comprising 11 standardized sea-containers. Container 1 comprises equipment for the construction of the inner casing from metal sheets. It also contains storage room for at least one day production. The metal sheets are formed by rollers into a tube formed sheet and longitudinally laser welded. In container 2 the separate tube are welded together to form the inner casing. In this container the inner casing is continuously moving. Also the welding apparatus is continuously moving at the same speed. During welding the inner casing and the newly made tube are clamped together by two connected expandable clamps. The clamps are fixed inside the pipes onto both ends. Before welding the space between the clamps is filled with an inert gas. Container 3 comprises a caterpillar controlling unit to control the speed and tension of the elongated tube. The elongated tube is pushed away from the mobile unit by a caterpillar mover in a further container or is pulled away by a winch via a cable. The winch may be situated at a long distance from the mobile unit, or is situated alongside of the mobile unit, while at a far distance the cable rolls over a fixed pulley. To get the correct tension during manufacture of the elongated tube, the caterpillar unit in container 3 controls the speed and tension. In container 4 the outer casing is applied by helically winding metal strips around the inner casing. At the same time a curable adhesive precursor is applied between the casings and the layers in the outer casing. This container also comprises metal layer storage and adhesive precursor storage for at least the production of one day. In container 4 the elongated tubular body is heated to a temperature of about 180-200° C. in order to cure the adhesive precursor. In container 6 a protective outer coating is applied to the tubular body. After curing, the temperature of the tubular body cools down to about 140-160° C. In container 7 the temperature is reduced to less than 100° C., preferably less then 80° C. This results in the tubular body having its full strength is axial and radial direction. In container 8 a caterpillar unit is transporting the tubular body into the open atmosphere. Container 9 contains the command and control equipment of all equipment in the containers. Container 10 contains air conditioning equipment to control the atmosphere in all containers. It especially controls the duct content, the humidity and the temperature of the air in the containers. Container 11 offers housing facilities to the operators of the mobile unit. All containers are detachably connected to each other with connection means 20. The containers 1 to 8 are further connected to each other by bellow seals through which the elongated tubular body is transported through all containers. Container 11 may be connected to the other containers or not. Preferably the container is not connected to the other containers to avoid transportation of vibrations and noise.

In FIG. 2 another outlay is described for a mobile unit. Containers 1 to 4 and 9 and 10 are similar to the containers described in FIG. 1. Container 5 contains equipment to apply further layers of metal strip around the tubular body. It also contains storage of material for at least one day production. Containers 6 and 7 comprise the curing of the adhesive precursor and the application of the outer casing. Container 8 comprises a winch. Cable 16 transports the finished tubular body (not shown) via a fixed pulley 17. In general, transport via a winch is preferred as it prevents the finished tubular body from buckling.

1. A mobile unit, suitable for the construction of an elongated tubular body comprising an elongated, tubular inner hollow core, an elongated, tubular inner casing and an elongated, tubular outer casing, the inner casing surrounding the hollow core, the outer casing surrounding the inner casing, the outer casing comprising one or more layers, each layer consisting of one or more helically wound metal strips, the inner casing and the outer casing as well as any layers in the outer casing being bound to each other by an adhesive, which elongated body has been made by a process comprising constructing the elongated inner casing, providing one or more metal strips, winding the one or more metal strips helically around the inner casing, providing adhesive or a curable adhesive precursor and applying it between the casings and the layers, followed by curing the adhesive precursor when present, with the proviso that when two or more layers are present in the outer casing of the elongated tubular body or when overlapping layers are present in the outer casing there may or may not be an adhesive layer between the inner and the outer casing of the elongated tubular body, the mobile unit comprising a multitude of detachably connected containers, each container comprising equipment to carry out one or more of the process steps as described above.

2. A mobile unit according to claim 1, comprising at least one container in which equipment is present for the construction of the elongated inner casing, and/or comprising at least one container in which equipment is present for winding the one or more metal strips around the inner casing, and/or comprising at least one container comprising equipment for the curing of curable adhesive precursor, and/or comprising at least one container comprising equipment for the continuous movement of the tubular body or its intermediate parts, and/or comprising a container provided with equipment to apply a coating onto the outer casing of the elongated tubular body.

3. A mobile unit according to claim 1, in which the mobile unit comprises at least one additional container comprising equipment to provide conditioned air to be used to control the climate in one or more of the other containers, in which the additional container comprising equipment to provide conditioned air to be used to control the climate in one or more of the other containers, comprises equipment to control the temperature of the air, the humidity of the air and/or the dust content of the air, especially for all other containers.

4. A mobile unit according to claim 1, in which one or more containers comprise equipment to provide conditioned air to be used to control the climate in the container, the container especially containing equipment to control the temperature of the air, the humidity of the air or the dust content of the air.

5. A mobile unit according to claim 1, in which the mobile unit comprises one or more containers comprising equipment to create tension in the elongated pipeline, e.g. caterpillar equipment.

6. A mobile unit according to claim 1, in which the mobile unit comprises at least one additional container comprising monitoring and/or controlling equipment to monitor and/or control the processes carried out in one or more of the other containers.

7. A mobile unit according to claim 1, in which the mobile unit comprises one or more standardized sea containers.

8. A mobile unit according to claim 1, in which the mobile unit comprises containers which are liftable, especially by helicopter or crane, preferably have a weight up till 30 tons, preferably up till 25 tons.

9. A mobile unit according to claim 1, in which the mobile unit comprises strengthening constructions to connect three or more containers to each other in addition to the direct connections between the containers, a frame connecting the containers to each other, in which all containers in which the elongated tubular body is produced are connected to each other by means of a strengthening construction.

10. A mobile unit according to claim 1, which mobile unit comprises one or more seals connecting openings in one container with openings in adjacent containers, especially for transport of the elongated tubular body or its precursors from one container to another container, the seals flexible seals, especially bellows.

11. A mobile unit according to claim 1, in which the pressure in at least the elongated producing containers is above ambient pressure.

12. (canceled)

13. Connectable containers comprising one or more pieces of equipment to carry out one or more of the process steps as defined in claim 1.

14. A mobile unit according to claim 1, in which the elongated tubular body comprises an outer casing comprises at least two layers, each layer consisting of one or more longitudinally preformed, flat elongated metal strips, the preforming of the strips such that the strips have been bent helically in such a way that the consecutive windings of the helix touch or almost touch to each other, each strip in one layer overlapping with other strips in other layers, the layers in the outer casing being bound to each other by an adhesive, which elongated body has been made by a process comprising constructing an elongated inner casing, providing one or more first flat elongated metal strips, plastically preforming the one or more first metal strips in a bending process to obtain one or more helices and applying the one or more preformed first metal strips onto the inner casing to form the first layer of the outer casing, applying a layer of adhesive or curable adhesive precursor, providing one or more second flat, elongated metal strips, plastically preforming the one or more second metal strips in a bending process to obtain one or more helices and applying the preformed one or more second metal strips on the first layer of the outer casing to form the second layer of the outer casing, optionally followed by the further application of one or more additional layers of adhesive or curable adhesive precursor and preformed flat, elongated metal strips, optionally followed by a curing process to cure the adhesive precursor.
